(19) United States
(12) Patent Application Publication
(10) Pub. No.: US 2007/0292251 A1
(43) Pub. Date: Dec. 20, 2007

(54) Dock trailer and method for animal dock jumping

(76) Inventor: Tony Reed, Pittsburg, CA (US)

Correspondence Address: KRAMER & AMADO, P.C., 1725 DUKE STREET, SUITE 240, ALEXANDRIA, VA, 22314, US

(21) Appl. No.: 11/812,568

(22) Filed: Jun. 20, 2007

Related U.S. Application Data
(60) Provisional application No. 60/805,282, filed on Jun. 20, 2006.

(51) Int. Cl. B60P 1/00

(52) U.S. Cl. 414/538

(57) ABSTRACT

A dock trailer for animal dog jumping and associated method, including one or more of the following: placing a pool on a pallet; securing the pool to the pallet; aligning the pallet with the trailer; extending a boom from the trailer; extending a tether from the trailer or the boom; attaching the tether to the pallet; starting to pull the tether towards the trailer; pulling the pallet up a ramp of the trailer; raising the pallet to a level wherein a bottom surface of the pallet is above a top surface of the trailer; retracting the boom into the trailer; aligning the pallet with a receptacle in the trailer; lowering the pallet into the receptacle of the trailer; receiving the pallet in the receptacle of the trailer; stopping to pull the tether towards the trailer; securing the pallet in the trailer receptacle; and securing the pallet to the trailer.

This nonprovisional application claims priority under 35 U.S.C. § 119(e) to U.S. Provisional Application No. 60/805,282 filed on Jun. 20, 2006, the entire contents of which are hereby incorporated by reference.

### BACKGROUND OF THE INVENTION

1. Field of the Invention

This invention relates generally to dock trailers for animal dock jumping.

2. Description of Related Art

The use of docks for marine activities including boating has been known for centuries. The existence of pet animals in the vicinity of such docks has been equally well known. Likewise, it is not uncommon, to see a pet jump from a fixed dock structure into a naturally occurring body of water into which the fixed dock structure is built. Similarly, it is not unusual to see a pet run the length of a dock and jump into a natural body of water such as a river or lake.

In fact, a competitive industry has developed wherein the competition consists of pets running down docks and jumping into bodies of water. Such competitions occur over time in different locations. Thus, there is a need for a dock trailer for animal dock jumping.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for a dock trailer for animal dock jumping, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

One exemplary embodiment is a method for a dock trailer for animal dog jumping including placing a pool on a pallet, securing the pool to the pallet, aligning the pallet with the trailer, extending a tether from the trailer, attaching the tether to the pallet, starting to pull the tether towards the trailer, pulling the pallet up a ramp of the trailer, receiving the pallet in a receptacle of the trailer, stopping to pull the tether towards the trailer, and securing the pallet to the trailer.

Another exemplary embodiment is a method for a dock trailer for animal dog jumping, including placing a pool on a pallet, securing the pool to the pallet, aligning the pallet with the trailer, extending a boom from the trailer, extending a tether from the boom, attaching the tether to the pallet, raising the pallet to a level wherein a bottom surface of the pallet is above a top surface of the trailer, retracting the boom into the trailer, aligning the pallet with a receptacle in the trailer, lowering the pallet into the receptacle of the trailer, and securing the pallet in the trailer receptacle.

A further exemplary embodiment is a method for a dock trailer for animal dog jumping including securing a spool on a bed of the trailer, attaching an edge of a pool to the spool; and actuating the spool to secure an entire portion of the pool. In various exemplary embodiments, actuating the spool to secure the entire pool includes rotating a handle, either manually or automatically, such as by a motorized winch.

One embodiment is a dock trailer for animal dog jumping, including a bed, a winch, a tether, a ramp, a pallet, a pool, straps securing the pool to the pallet, and a receptacle securing the pallet to the bed. Another embodiment is a dock trailer for animal dog jumping, including a bed, a pallet, a pool, a boom, straps that secure the pool to the pallet, a motorized portion attached to the boom, and a tether that extends from the motorized portion, wherein the boom extends from the bed and the tether attaches to the pallet so as to raise the pallet and secure the pallet in a receptacle attached to the bed.

A further embodiment is a dock trailer for animal dog jumping, including a bed, a spool having a retractor, the spool securely attached to the bed, and a pool securely attached to the spool. In various exemplary embodiments, the retractor is a handle. In various exemplary embodiments, the retractor is a motorized winch.

In various exemplary embodiments the pallet has wheels. In various exemplary embodiments, the receptacle comprises two parallel tracks. In various exemplary embodiments, the tether is attached to the trailer by a motorized winch. In various exemplary embodiments, the tether extends from a motorized winch that is attached to the boom. In various exemplary embodiments, the pool is secured to the pallet by straps. In various exemplary embodiments, the pool is secured to the pallet by a crossing pattern of the straps.

In various exemplary embodiments, the pallet is omitted. For example, in various exemplary embodiments straps secure a pool and attach to a tether without the use of a pallet.

### BRIEF DESCRIPTION OF THE DRAWINGS

In order to better understand various exemplary embodiments, reference is made to the accompanying drawings, wherein:

FIG. 1 is a perspective view of a first exemplary embodiment of a dock trailer for animal dock jumping;

FIG. 2 is a perspective view of the exemplary embodiment of the dock trailer for animal dock jumping according to FIG. 1 under construction;

FIG. 3 is a perspective view of the exemplary embodiment of the dock trailer for animal dock jumping according to FIG. 1 used with a natural body of water;

FIG. 4 is a perspective view of the exemplary embodiment of the dock trailer for animal dock jumping according to FIG. 1 used with a pool of water;

FIG. 5 is a fragmented perspective view showing exemplary components of the exemplary embodiment of the dock trailer for animal dock jumping of FIG. 1;

FIG. 6 is a fragmented perspective view showing an exemplary side storage compartment of the exemplary embodiment of the dock trailer for animal dock jumping according to FIG. 1;

FIG. 7 is a perspective view of the exemplary embodiment of the dock trailer for animal dock jumping according to FIG. 1 showing an exemplary side storage area and an exemplary rear storage area;

FIG. 8 is a second perspective view of the exemplary embodiment of the dock trailer for animal dock jumping according to FIG. 1;

FIG. 9 is a fragmented perspective view of a second exemplary embodiment of a dock trailer for animal dock jumping;

FIG. 10 is a fragmented perspective view of a third exemplary embodiment of a dock trailer for animal dock jumping;

FIG. 11 is a fragmented perspective view of a fourth exemplary embodiment of a dock trailer for animal dock jumping;

FIG. 12 is a flowchart of a first exemplary method for a dock trailer for animal dock jumping;

FIG. 13 is a flowchart of a second exemplary method for a dock trailer for animal dock jumping;

FIG. 14 is a flowchart of a third exemplary method for a dock trailer for animal dock jumping; and

FIG. 15 is a fragmented perspective view of a fifth exemplary embodiment of a dock trailer for animal dock jumping.

### DETAILED DESCRIPTION OF THE PREFERRED EMBODIMENTS OF THE INVENTION

Because formal competitions or exhibitions related to animals jumping from docks into water have become so popular, it is desirable to have systems and methods of performing such competitions and exhibitions in geographical locations that are not proximate to a naturally occurring body of water. Some such competitions might not even be proximate to an in ground pool of water. Thus, it is desirable to have a dock trailer and method for animal dock jumping that includes both a dock trailer and a pool of water into which the animal jumps.

Likewise, the organizers of animal jumping competitions and exhibitions, often travel from one location to another to put on the competitions and exhibitions. Thus, it is also desirable that a dock trailer and pool for animal dock jumping be portable.

Some embodiments of a portable dock trailer and method for animal dock jumping require scaffolding and the assembly of scaffolding. However, such structures and methods are cumbersome. Thus, it is desirable to have a dock trailer and method for animal dock jumping that does not require the assembly or transportation of scaffolding. Accordingly, various exemplary embodiments described herein are a dock trailer and method for animal dock jumping that includes a pool and is portable without requiring scaffolding.

One common variety of competitions and exhibitions related to animal dock jumping is focused on dogs. Thus, references herein to dog dock jumping, and other references herein to dogs in general, should be understood to include other exemplary embodiments wherein the animal is an animal other than a dog.

Referring now to the drawings, in which like numerals refer to like components or steps, there are disclosed broad aspects of various exemplary embodiments.

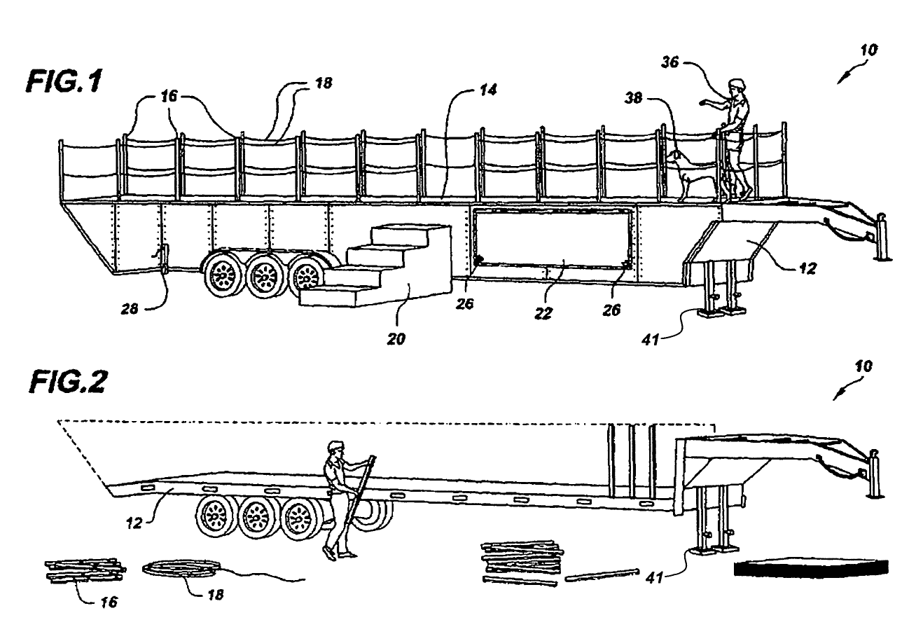

FIG. 1 is a perspective view of a first exemplary embodiment of a dock trailer for animal dock jumping 10. The first exemplary embodiment of a dock trailer for animal dock jumping 10 includes a trailer 12, a runway or platform 14, railing poles 16, a rope railing 18, stairs 20, a storage compartment 24, locking handles 26, opening means 28, and rear storage door 30. One or more of these features are shown in other Figures.

FIG. 1 also shows a dog handler 36 and a dog 38 standing on the runway/platform 14. The runway/platform 14 is also refereed to herein as the bed 14 of the trailer 12. In various exemplary embodiments the trailer 12 is twenty to forty feet long. In various exemplary embodiments, the trailer 12 is more than forty feet long, such as forty-five feet long. In various exemplary embodiments, the runway/platform 14 is forty feet long. In various exemplary embodiments, the runway/platform 14 is eight feet wide.

As can be seen in FIG. 1, the runway/platform 14 is bordered by the poles 16 and a rope railing 18. The stairs 20 provide easy access to the runway/platform 14. In various exemplary embodiments, the stairs 20 are removable.

FIG. 2 is a perspective view of the exemplary embodiment of the dock trailer for animal dock jumping 10 under construction. As shown in FIG. 2, the railing pole 16 and rope railing 18 can be disassembled from the trailer 12.

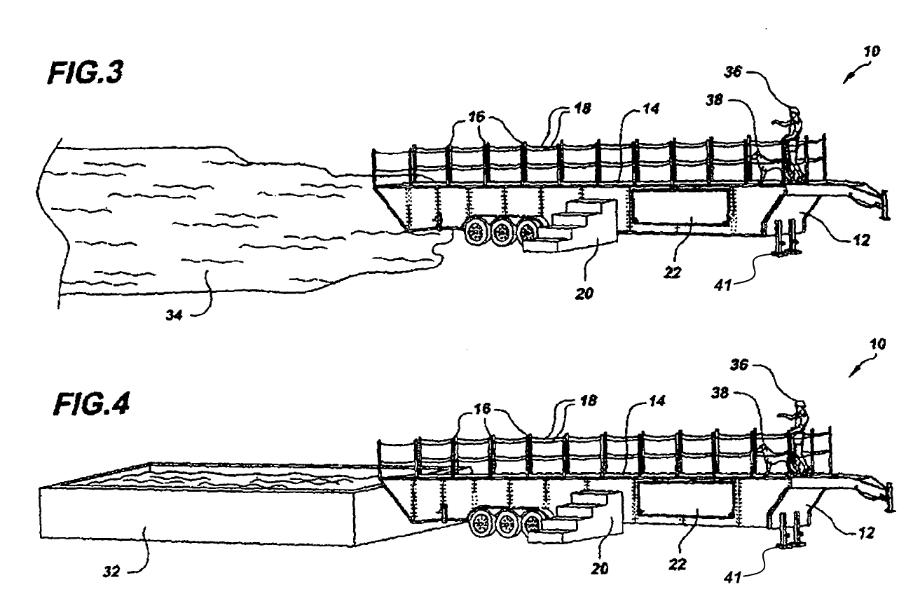

FIG. 3 is a perspective view of the exemplary dock trailer for animal dock jumping 10 used with the natural body of water 34. While much of the subject matter discussed herein is focused on the use of a pool of water, it should be apparent that the subject matter disclosed herein may also be used in connection with animal dock jumping competitions and exhibitions wherein the animal jumps into a natural body of water 34.

FIG. 4 is a perspective view of the exemplary dock trailer for animal dock jumping 10 used with a pool of water 32. In various exemplary embodiments, the pool of water 32 attaches to the trailer 12 forming a single assembly that is a dock trailer and pool for animal dock jumping. In various exemplary embodiments, the trailer 12 includes a receptacle for receiving the pool 32. This will be discussed in greater detail below.

FIG. 5 is a fragmented perspective view showing components of the exemplary dock trailer for animal dock jumping 10. The view shown in FIG. 5 corresponds to a stage during the assembly or disassembly of the exemplary trailer 12. As depicted in FIG. 5, the rope railing 18 is not attached to the railing pole 16.

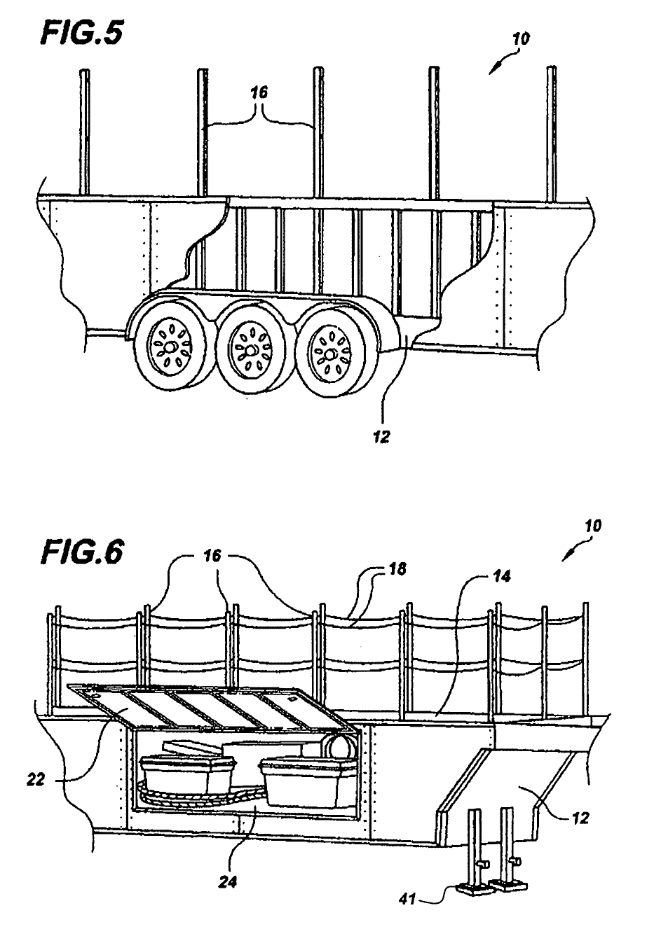

FIG. 6 is a fragmented perspective view showing an exemplary side storage compartment 24 of the exemplary dock trailer for animal dock jumping 10. The side compartment 24 is covered by a door 22. The door 22 is depicted in a lifted position in FIG. 6 revealing supplies stored in the storage compartment 24.

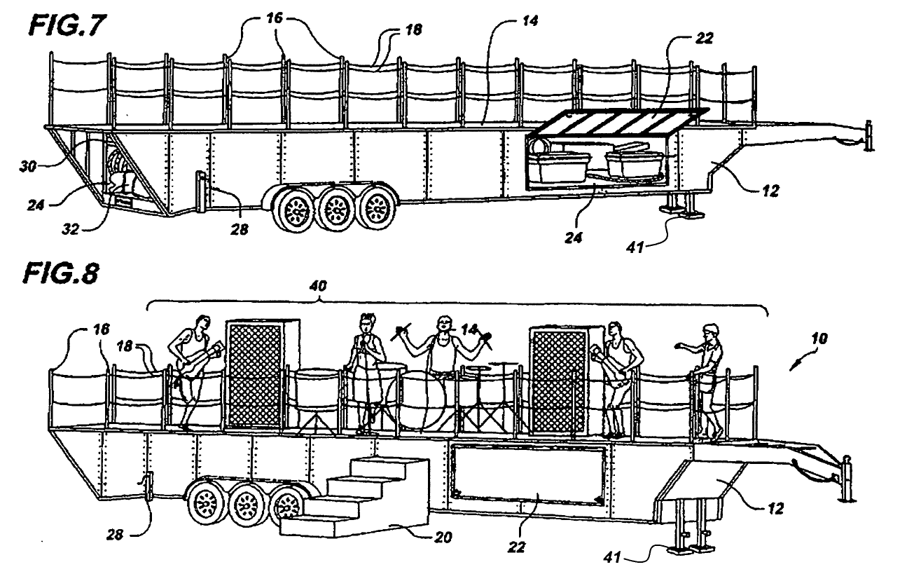

FIG. 7 is a perspective view of the exemplary dock trailer for animal dock jumping 10 showing the exemplary side storage compartment 24 and an exemplary rear storage compartment 25. It should be apparent that the location of one or more storage compartments 24, 25 in the trailer 12 underneath the runway/platform 14 vary according to various exemplary embodiments.

FIG. 8 is a second perspective view of the exemplary dock trailer for animal dock jumping 10. The second perspective view of the dock trailer for animal dock jumping 10 depicts a music band 40. Thus, it should be apparent that the various dock trailers and methods for animal dock jumping described herein do not preclude other beneficial uses of the trailer 12.

In various exemplary embodiments, the trailer 12 includes jacks 41. The various views in FIGS. 1-4 and 6-8 are intended to show the jacks 41 adjusted to a variety of heights. Accordingly, it should be apparent that a height of the runway/platform 14 off the ground can be adjusted by adjusting a height of the jacks 41. In various exemplary embodiments, jacks 41 are located in all four corners of the trailer 12.

In various exemplary embodiments, the jacks are actuated in a manual fashion, for example, by cranking the handle. Similarly, in various exemplary embodiments, that the jacks are actuated automatically, for example, by hydraulics or by a motor.

According to the foregoing, various exemplary embodiments are used for dog jumping competitions wherein the dog 38 runs down the dock trailer platform 14 and jumps into a body of water such as the pool of water 32 or the naturally occurring body of water 34. In various exemplary embodiments, the trailer 12 includes a storage compartments 24 on both sides and in the rear.

In various exemplary embodiments, the trailer 12 is backed into the naturally occurring body of water 34. Thus, in various exemplary embodiments, the trailer 12 rests on the bottom of a lake, pond, ocean, river or other naturally occurring body of water such that the dog 38 may run down the platform 14 directly into the body of water 34 without jumping.

In still other embodiments, a lower surface of the trailer 12 is fitted with pontoons that enable the trailer 12 to float. Thus, in various exemplary embodiments, the trailer 12 is backed into the naturally occurring body of water 34 while maintaining a height of the platform 14 above a surface of the naturally occurring body of water 34 such that the dog 38 must jump from the platform 14 into the body of water 34 after running down the platform 14 during a competition or exhibition.

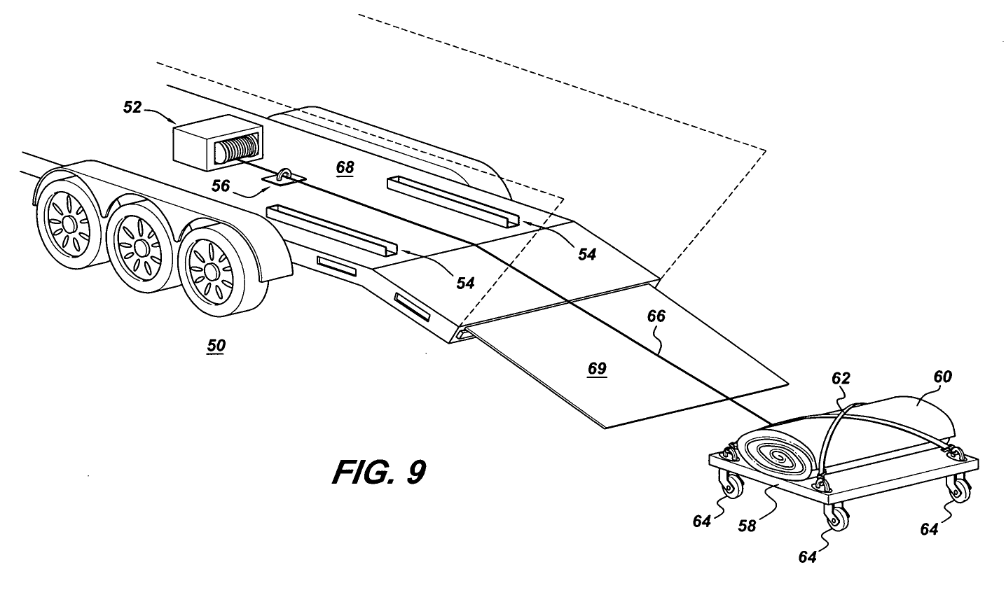

FIG. 9 is a fragmented perspective view of a second exemplary embodiment of a dock trailer for animal dock jumping 50. The dock trailer 50 includes a winch 52, receptacles 54, a ring 56, a pallet 58, a pool 60, a tether 66, a bed 68 and a ramp 69. The pallet 58 includes straps 62 and wheels 64.

The straps 62 secure the pool 60 to the pallet 58. The wheels 64 of the pallet 58 fit into the receptacles 54. The tether 66 is used to pull the pallet 58 up the ramp 69 and onto the bed 68 of the trailer 50 in the receptacles 54. The pallet 58 can then be secured to the ring 56 by a hook or other suitably sturdy fastener.

The winch 52 provides the force to retract the tether 66 when attached to the pallet 58. It should be apparent that, in other exemplary embodiments, the pallet 58 is manually pushed up the ramp 69 onto the bed 68.

In various exemplary embodiments, the ramp 69 is constructed from one piece. In other exemplary embodiments, the ramp 69 consists of two pieces that align with the wheels 64 of the pallet 58.

In various exemplary embodiments, the tether 66 is a rope. In other exemplary embodiments, the tether 66 is a steel cable. It should be apparent that, in various exemplary embodiments, the tether 66 is fabricated from any material sufficiently strong to pull the pallet 58 onto the bed 68 by way of the ramp 69.

In various exemplary embodiments, the pallet 58 is omitted. Thus, in various exemplary embodiments, the straps 62 secure the pool 60 and the tether 66 attaches directly to the pool 60 as secured by the straps 62.

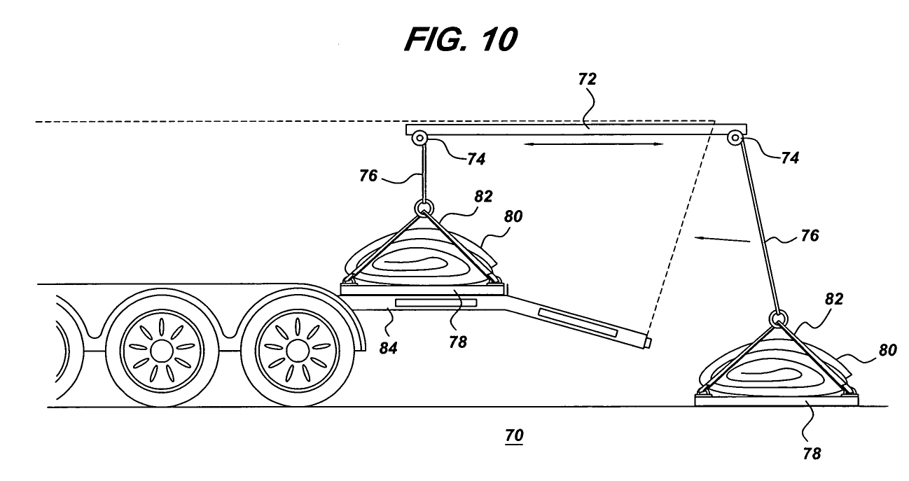

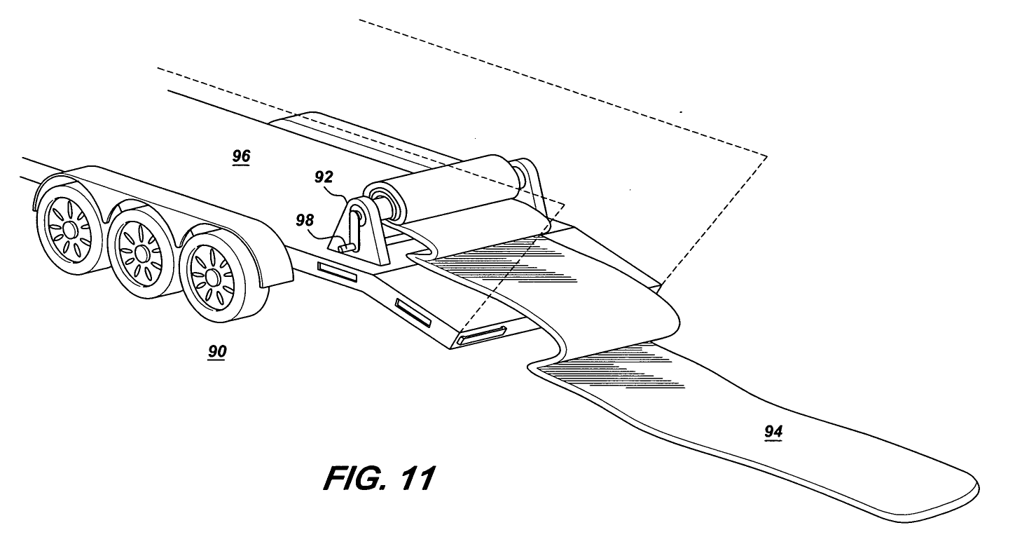

FIG. 10 is a fragmented perspective view of a third exemplary embodiment of a dock trailer for animal dock jumping 70. The dock trailer for animal dock jumping 70 includes a boom 72, a pallet 78 and a pool 80. The pallet 78 includes fasteners 82. The boom 72 includes a winch 74 and a tether 76.

The boom 72 extends horizontally from left to right. The tether 76 extends away from the winch 74. Thus, when the pallet 78 is on the ground, the boom 72 maybe extended away from the bed 84 of the trailer 70, in a direction to the right in FIG. 10, and the tether 76 extends to fasten to the fasteners 82 on the pallet 78. The fasteners 82 hold the pool 80 to the pallet 78.

Subsequently, force exerted from the winch 74 retracts the tether 76 raising the pallet 78 off the ground to a level at or above a level of the bed 84. The boom 72 then retracts into the trailer 70, in a direction to the left in FIG. 10, until the pallet 78 is above receptacles in the bed 84 of the trailer 70.

The receptacles in the bed 84 of the trailer 70 are similar to the receptacles 54 shown in connection with the second exemplary embodiment of a dock trailer for animal dock jumping 50. It should be apparent that, according to various exemplary embodiments, any form of a receptacle capable of receiving and securing the pallet 78 are implemented in various exemplary embodiments of the dock trailers for animal dog jumping described herein.

According to the foregoing, the pallet 78 is secured to the bed 84 of the trailer 70 in the receptacles. In various exemplary embodiments, the pallet 78 is strapped to the bed 84 of the trailer 70. In various exemplary embodiments, the pallet 78 is secured to the bed 84 of the trailer 70 by screws or nuts and bolts.

In various exemplary embodiments, the straps 82 follow a crossing pattern to secure the pool 80 to the pallet 78. It should be apparent that the straps 62 are also shown in a crossing pattern to secure the pool 60 to the pallet 58.

In various exemplary embodiments, the pallet 78 is omitted. Thus, in various exemplary embodiments, the straps 82 secure the pool 80 and the tether 76 attaches directly to the pool 80 as secured by the straps 82.

FIG. 11 is a fragmented perspective view of a fourth exemplary embodiment of a dock trailer for animal dock jumping 90. The dock trailer for animal dog jumping 90 includes a spool 92, a pool 94 and a bed 96. The spool 92 is secured to the bed 96 of the trailer 90. The pool 94 is shown extending away from the spool 92. As shown, an edge of the pool 94 fits in a slot in the spool 92.

In various exemplary embodiments, the spool 92 is actuated to secure the entire pool 94. Thus, in various exemplary embodiments, a handle 98 is cranked to roll the pool 94 onto the spool 92.

In various exemplary embodiments, the handle 98 is cranked manually. In other exemplary embodiments, the handle 98 is actuated automatically. For example, in some embodiments, the handle 98 is actuated by a motor such as a winch. It should be apparent that in other exemplary embodiments, any known, or later developed, means of actuating a spool 92 is implemented.

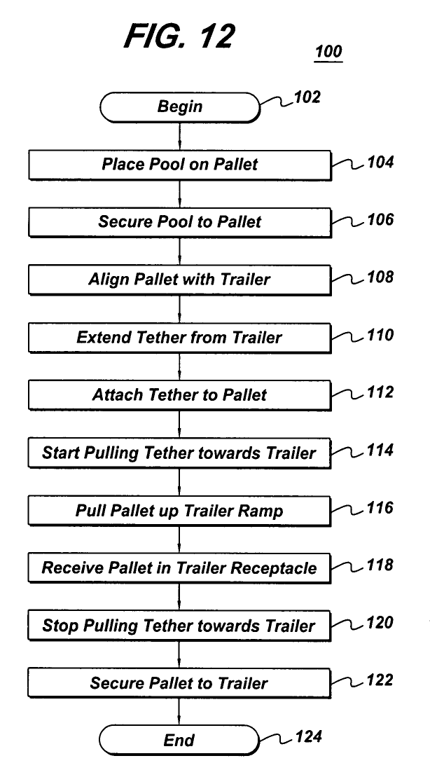

FIG. 12 is a flowchart of a first exemplary embodiment of a method for a dock trailer for animal dock jumping 100. The method 100 begins in step 102 and continues to step 104 where a pool is placed on a pallet. An exemplary embodiment of structure associated with the exemplary method 100 is shown in FIG. 9.

Following step 104, the method 100 continues to step 106 where the pool is secured to the pallet. Next, the method 100 proceeds to step 108 where the pallet is aligned with the trailer.

Then, the method 100 proceeds to step 110 where a tether is extended from the trailer. Following step 110, the method 100 proceeds to step 112 where the tether is attached to the pallet.

The method 100 then proceeds to step 114 where the tether is started pulling towards the trailer. As the tether is pulled towards the trailer in step 114, the pallet is correspondingly pulled towards the trailer because of the attachment of the tether to the pallet.

Eventually, the pallet reaches an edge of a ramp leading from the ground up into the trailer. Subsequently, as the tether continues to pull towards the trailer, the pallet is pulled up the ramp in step 116.

The method 100 then proceeds to step 118 where the pallet is received in a receptacle in the trailer. Once the pallet is received in an appropriate position in the receptacle in trailer, the method 100 proceeds to step 120 where the pulling of the tether towards the trailer is stopped.

Next, in step 122, the pallet is secured to the trailer. Once the pallet is secured to the trailer, the method 100 proceeds to step 124 where the method 100 ends. It should be apparent that the structure used to accomplish the various steps of the method 100 corresponds to various exemplary embodiments of the dock trailer for animal dog jumping described herein.

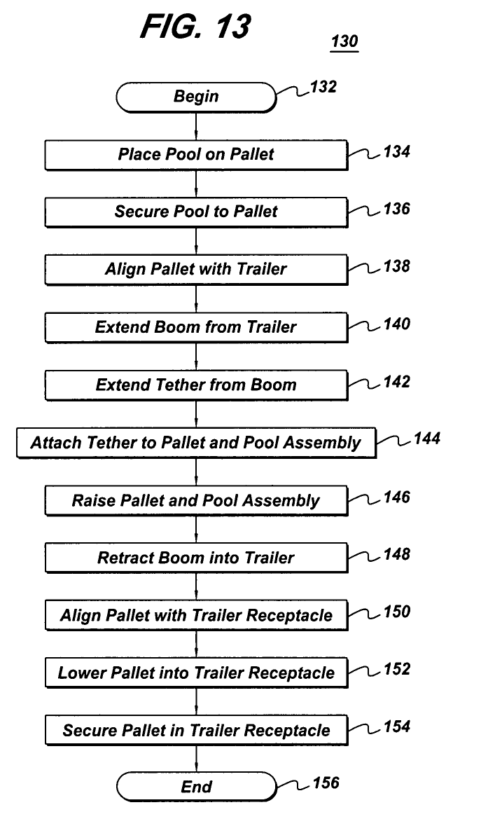

FIG. 13 is a flowchart of a second exemplary method for a dock trailer for animal dock jumping 130. The method for a dock trailer for animal dog jumping 130 begins in step 132. The method 130 then continues to step 134. Steps 134, 136 and 138 correspond to steps 104, 106 and 108 in exemplary method 100.

The method 130 then proceeds to step 140 where a boom is extended from the trailer. Next, in step 142, a tether is extended from the boom towards the ground. Thus, in step 140, the boom is extended from the trailer a sufficient distance such that the tether on the boom is above the pool and pallet on the ground.

The method 130 then proceeds to step 144 where the tether is attached to the pallet and pool assembly on the ground. Next, in step 146, a winch or other device on the boom is actuated to raise the pallet and pool assembly off the ground. The pallet and pool assembly is then raised into the air until a bottom edge of the pallet is above a top surface of a bed of the trailer. Then, in step 148, the boom is retracted into the trailer.

The method 130 then proceeds to step 150 where the pallet is aligned with a receptacle in the trailer. Once the pallet is aligned with a receptacle in the trailer in step 150, the method 130 proceeds to step 152. In step 152, the pallet is lowered into the receptacle in the trailer. The receptacle in the trailer is any type of receptacle capable of receiving the pallet.

The method 130 then proceeds to step 154 where the pallet is secured in the trailer receptacle. The method 130 then proceeds to step 156 where the method ends. An exemplary embodiment of structure used in connection with exemplary method 130 is shown in FIG. 10 and discussed above in connection with FIG. 10.

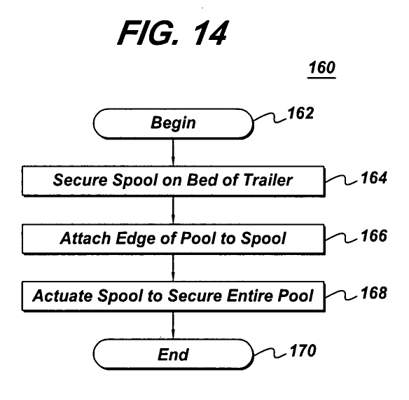

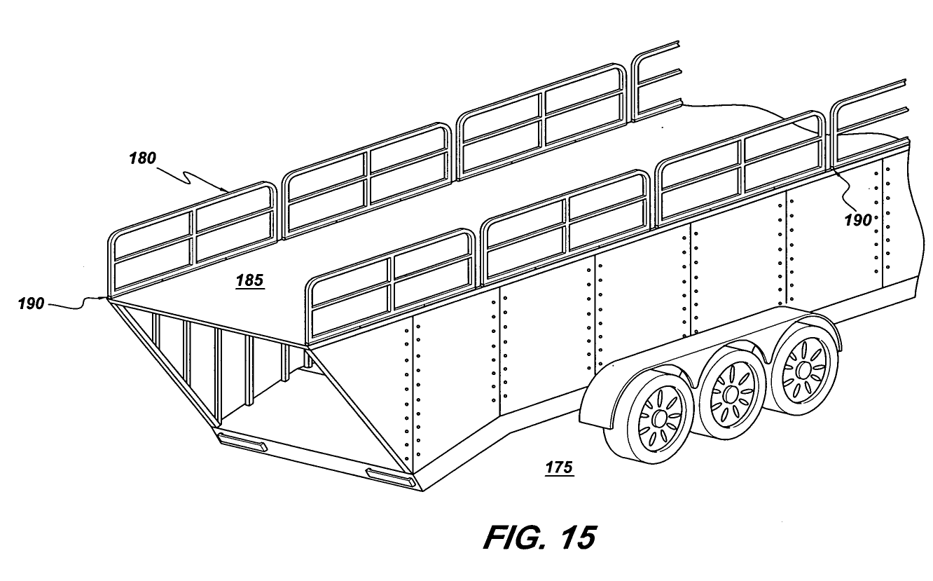

FIG. 14 is a flowchart of a third exemplary embodiment of a method for a dock trailer for animal dock jumping 160. The method for a trailer for animal dock jumping 160 begins in step 162. The method 160 then proceeds to step 164 where a spool is secured on a bed of a trailer. An exemplary embodiment of structure associated with method 160 is depicted in FIG. 11.

Following step 164, an edge of the pool is attached to the spool. Next, in step 168, the spool is actuated to secure the entire pool. Exemplary method 160 then proceeds to step 170 where the method 160 ends. Additional discussion of the various steps in exemplary method 160 is included above in connection with FIG. 11.

FIG. 15 is a fragmented perspective view of a fifth exemplary embodiment of a dock trailer for animal dock jumping 175. The dock trailer for animal dock jumping 175 includes a plurality of railings 180. In various exemplary embodiments, the railings 180 are attached to a bed or deck 185 of the dock trailer 175 by hinges 190. Thus, in various exemplary embodiments, the railings 180 fold inward onto the deck 185 of the dock trailer 175. In other exemplary embodiments, the railings 180 fold outward away from the deck 185.

In various exemplary embodiments, the railing 180 are eight feet long and four feet high. It should be apparent that, in various exemplary embodiments, the dimensions of the railings 180 are different than eight feet by four feet. It should also be apparent that, in various exemplary embodiments, the railings 180 collapse in a different manner and are attached in a different manner.

According to the foregoing, the subject matter described herein improves upon methods and apparatus for dog dock jumping events. For example, the subject matter described herein makes it easier to store and transport equipment associated with dog dock jumping competitions and exhibitions. Examples of some equipment often used in dog dock jumping competitions and exhibitions include a sound system, the stairs 20, tents, canopies, the pool 32, additional pools 32, and so on. In various exemplary embodiments, this equipment is stored in one or more of the storage compartments 24 during transportation.

In various exemplary embodiments, a sound system is built into the trailer. Accordingly, in various exemplary embodiments, the trailer includes electrical 110 watt receptacles. Similarly, in various exemplary embodiments, fluorescent lights are mounted inside the trailer. Thus, in various exemplary embodiments, the subject matter described herein is used to facilitate a dog dock jumping competition or exhibition at night.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method for a dock trailer for animal dog jumping comprising:
placing a pool on a pallet;
securing the pool to the pallet;
aligning the pallet with the trailer;
extending a tether from the trailer;
attaching the tether to the pallet;
starting to pull the tether towards the trailer;
pulling the pallet up a ramp of the trailer;
receiving the pallet in a receptacle of the trailer;
stopping to pull the tether towards the trailer; and
securing the pallet to the trailer.

2. The method for a dock trailer for animal dog jumping, according to claim 1, wherein the pallet has wheels.

3. The method for a dock trailer for animal dog jumping, according to claim 1, wherein the receptacle comprises two parallel tracks.

4. The method for a dock trailer for animal dog jumping, according to claim 1, wherein the tether is attached to the trailer by a motorized winch.

5. A method for a dock trailer for animal dog jumping, comprising;
placing a pool on a pallet;
securing the pool to the pallet;
aligning the pallet with the trailer;
extending a boom from the trailer;
extending a tether from the boom;
attaching the tether to the pallet;
raising the pallet to a level wherein a bottom surface of the pallet is above a top surface of the trailer;
retracting the boom into the trailer;
aligning the pallet with a receptacle in the trailer;
lowering the pallet into the receptacle of the trailer; and
securing the pallet in the trailer receptacle.

6. The method for a dock trailer for animal dog jumping, according to claim 5, wherein the receptacle is two parallel tracks.

7. The method for a dock trailer for animal dog jumping, according to claim 5, wherein the tether extends from a motorized winch that is attached to the boom.

8. The method for a dock trailer for animal dog jumping, according to claim 5, wherein the pool is secured to the pallet by straps.

9. The method for a dock trailer for animal dog jumping, according to claim 8, wherein the pool is secured to the pallet by a crossing pattern of the straps.

10. A method for a dock trailer for animal dog jumping comprising:
securing a spool on a bed of the trailer;
attaching an edge of a pool to the spool; and
actuating the spool to secure an entire portion of the pool.

11. The dock trailer for animal dog jumping, according to claim 10, wherein actuating the spool to secure the entire pool includes rotating a handle.

12. The dock trailer for animal dog jumping, according to claim 11, wherein the handle is rotated manually.

13. The dock trailer for animal dog jumping, according to claim 11, wherein the handle is rotated automatically.

14. The dock trailer for animal dog jumping, according to claim 13, wherein the handle is rotated by a motorized winch.

15. A dock trailer for animal dog jumping, comprising:
a bed;
a winch;
a tether;
a ramp;
a pallet;
a pool;
straps securing the pool to the pallet; and
a receptacle securing the pallet to the bed.

16. The dock trailer for animal dog jumping, according to claim 15, wherein the receptacle comprises parallel tracks.

17. The dock trailer for animal dog jumping, according to claim 15, wherein the pallet includes wheels.

18. The dock trailer for animal dog jumping, according to claim 15, wherein the straps secure the pool to the pallet in a crossing pattern.

19. A dock trailer for animal dog jumping, comprising:
a bed;
a pallet;
a pool;
a boom;
straps that secure the pool to the pallet;
a motorized portion attached to the boom; and
a tether that extends from the motorized portion,
wherein the boom extends from the bed and the tether attaches to the pallet so as to raise the pallet and secure the pallet in a receptacle attached to the bed.

20. The dock trailer for animal dog jumping, according to claim 19, wherein the receptacle is a pair of parallel tracks.

21. The dock trailer for animal dog jumping, according to claim 19, wherein the straps secure the pool to the pallet in a crossing pattern.

22. A dock trailer for animal dog jumping, comprising:
a bed;
a spool having a retractor, the spool securely attached to the bed; and
a pool securely attached to the spool.

23. The dock trailer for animal dog jumping, according to claim 22, wherein the retractor is a handle.

24. The dock trailer for animal dog jumping, according to claim 22, wherein the retractor is a motorized winch.
